(19) United States
(12) Patent Application Publication
(10) Pub. No.: US 2011/0191515 A1
(43) Pub. Date: Aug. 4, 2011

(54) Internet Synchronization Timepiece System

(76) Inventor: Tai Wai Luk, Hong Kong (HK)

(21) Appl. No.: 12/699,876

(22) Filed: Feb. 4, 2010

(51) Int. Cl. G04C 11/02; G06F 1/04; G06F 13/00; G06F 15/16

(52) U.S. Cl. 710/303; 368/47; 713/400; 709/248

(57) ABSTRACT

An internet synchronization timepiece system includes a timepiece having a timepiece signal transceiver and a time-keeping synchronization hub. The time-keeping synchronization hub includes a hub casing connected to a computer, a time-keeping device received in the hub casing for periodically receiving the real-time time and the weather forecast information acquired through internet, and a synchronization transceiver received in the hub casing for transmitting synchronized time information and the weather forecast information in a wireless manner as time signal and weather forecast signal to the timepiece.

### BACKGROUND OF THE PRESENT INVENTION

1. Field of Invention

The present invention relates to a timepiece, and more particularly to an internet synchronization timepiece system, wherein a timepiece is arranged to synchronize with internet time and acquire weather forecast information through internet.

2. Description of Related Arts

A convention timepiece, such as an analog quartz watch or an analog quartz clock, is driven by quartz crystal for displaying time information. Generally speaking, quartz crystal has very good accuracy in producing time signal so that it is widely accepted as a core element in most timepieces. Despite its generally high accuracy, there exist a small amount of tolerances in its oscillations. These tolerances are generally immaterial over a short period of time because users may not notice the small amount of tolerances. Unfortunately, these tolerances accumulate over time, so that when the timepiece is used for a relatively longer period of time (such as over a period of few months), the accumulated tolerances become noticeable as reflected by the timepiece's inaccuracy in displaying time information.

Radio controlled atomic timepieces have been developed in which time information of quartz crystal driven timepieces is capable of being synchronized with an external time signal so that the tolerance accumulation problem of a quartz-driven timepiece can be minimized. The theory is that while the quartz crystals in such timepieces still have tolerances, the inaccuracy of time information display can be cured by periodic synchronization of the timepiece's time with the external time signal. The external time signal usually comes from an officially established institution having very accurate time information derived from an atomic clock.

The problem here is that there are merely limited countries which have atomic clock signal transmission services (example includes USA, UK, Germany, Japan, China, Switzerland and France). There are many other countries which do not have this kind of time signal transmission service. As a result, for those timepieces which are to be used in these countries, the correction of tolerances of quartz crystal driven timepieces can only be done manually, in a highly inconvenient and inaccurate fashion.

Moreover, conventional atomic timepieces have various reception problems. When the timepieces are utilized in indoor environment or when the weather condition is not good (such as in cloudy days), conventional atomic timepieces will have poor reception of time signal. In this situation, the time displayed by such atomic timepieces is derived from internal timekeeping and therefore subject to great tolerances.

Apart from time display problem as mentioned above, conventional timepieces are usually not able to provide accurate weather forecast information. There exist some watches which have pressure sensors installed thereon. These pressure sensors are arranged to monitor changes in atmospheric pressure so as to predict weather conditions for a predetermined period of time. However, this kind of watches is not able to make an accurate prediction of weather condition.

### SUMMARY OF THE PRESENT INVENTION

A main object of the present invention is to provide an internet synchronization timepiece system, wherein a timepiece is arranged to periodically synchronize with internet time and acquire weather forecast information through internet.

Another object of the present invention is to provide an internet synchronization timepiece system, which comprises a timepiece and a synchronization hub arranged to be detachably connected to a computer so as to acquire accurate time and weather forecast signal through internet.

Another object of the present invention is to provide an internet synchronization timepiece system, wherein the timepiece and the synchronization hub is electrically communicated, preferably in a wireless manner, so that synchronized time information and weather forecast information can be periodically and wirelessly sent to the timepiece for automatic time adjustment and weather forecast display.

Accordingly, in order to accomplish the above objects, the present invention provides an internet synchronization timepiece system, comprising:

a time-keeping synchronization hub, which comprises:

a hub casing having an inlet port adapted for electrically connected with a computer which is pre-programmed to periodically send out real-time time and weather forecast information acquired from internet to the inlet port;

a time-keeping device received in the hub casing and electrically connected with the inlet port of the hub casing for periodically receiving the real-time time and the whether forecast information acquired through internet, wherein the time-keeping device is periodically synchronized with the real-time time information acquired through the internet; and

a synchronization transceiver received in the hub casing for transmitting synchronized time information and the weather forecast information in a wireless manner as time signal and weather forecast signal; and

a timepiece, which comprises:

a timepiece casing;

a timepiece core comprising a time displaying device received in the casing; and

a timepiece signal transceiver received in the timepiece casing and electrically connected with the timepiece core for wirelessly receiving the time signal and the weather forecast signal in a periodic manner, wherein the timepiece core is arranged to synchronize with the time signal and interpret the weather forecast signal to display the weather forecast information and the time information transmitted from the time-keeping synchronization hub by the time displaying device.

The above mentioned objectives, features, and advantages of the present invention will be more clearly described and shown in the following detailed description, drawings, and the claims.

### BRIEF DESCRIPTION OF THE DRAWINGS

FIG. 1 is a perspective view of an internet synchronization timepiece system according to a preferred embodiment of the present invention.

FIG. 2 is a perspective view of the time-keeping synchronization hub according to the above preferred embodiment of the present invention.

FIG. 3 is a schematic diagram of the internet synchronization timepiece system according to a preferred embodiment of the present invention.

FIG. 4 is a method of displaying time and utility information by an internet synchronization system according to the preferred embodiment of the present invention.

FIG. 5 is an alternative mode of the internet synchronization timepiece system according to the preferred embodiment of the present invention.

### DETAILED DESCRIPTION OF THE PREFERRED EMBODIMENT

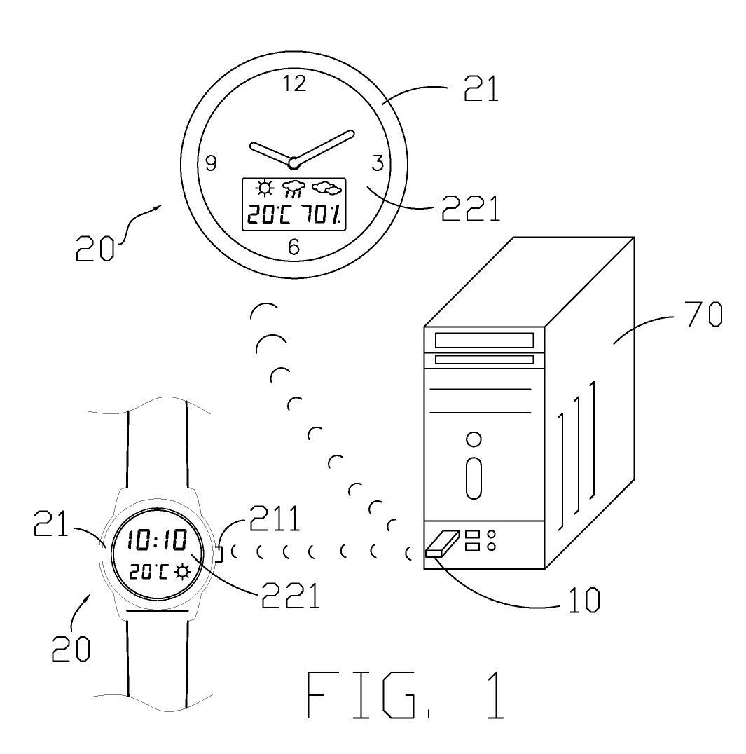

Referring to FIG. 1 to FIG. 3 of the drawings, an internet synchronization timepiece system according to a preferred embodiment of the present invention is illustrated, in which the internet synchronization timepiece system comprises a time-keeping synchronization hub 10, and at least one timepiece 20, such as a watch or a clock. The time keeping synchronization hub 10 comprises a hub casing 11, a time-keeping device 12, and a synchronization transceiver 13.

The hub casing 11 has an inlet port 111 adapted for electrically connected with a computer 70 which is pre-programmed to periodically send out real-time time information and a predetermined kind of utility information, such as weather forecast information, acquired from internet to the inlet port 111.

The time-keeping device 12 is received in the hub casing 11 and electrically connected with the inlet port 111 of the hub casing 11 for periodically receiving the real-time time information and the utility information, such as weather forecast information acquired through internet, wherein the time-keeping device 12 is periodically synchronized with the real-time time information acquired through the internet. The time-keeping device 12 is also arranged for keeping time automatically with reference to the latest time information acquired through the internet when real-time time information is not transmitted to it from the computer 70 (this situation may arise where the computer 70 is turned off or the computer is not online).

The synchronization transceiver 13 is received in the hub casing 11 for transmitting synchronized time information and the utility information (such as weather forecast information) in a wireless manner as time signal and utility information signal, such as weather forecast signal.

The timepiece 20 comprises a timepiece casing 21, a timepiece core 22 comprising a time displaying device 221 received in the timepiece casing 21, and a timepiece signal receiver 23.

The timepiece signal transceiver 23 is received in the timepiece casing 21 and electrically connected with the timepiece core 22 for wirelessly receiving the time signal and the utility information signal in a periodic manner. The timepiece core 22 is arranged to synchronize with the time signal and interpret the utility information signal to display the utility information, such as weather forecast information, and the time information transmitted from the time-keeping synchronization hub 10 by the time displaying device 221. Alternatively, the timepiece signal transceiver 23 may also receive the time signal and the utility information when it is actuated by at least one actuator 211 provided on the timepiece 20.

According to the preferred embodiment of the present invention, the hub casing 11 is adapted for electrically connecting to a regular USB port of a computer 70 pre-programmed to send out time information, the utility information such as the weather forecast information, and any other appropriate information such as date information. The crucial point is that internet updated information is sent out from the computer 70 to the timepiece 20 via the time-keeping synchronization hub 10.

The time-keeping device 12 comprises a time-keeping Central Processing Unit (CPU) 121 electrically communicated with the synchronization transceiver 13, and comprises a Central Processing Unit (CPU) core 1211, a timepiece motor driver 1212 linked with the CPU core 1211, a clock generator 1213 linked with the CPU core 1211 and is arranged to generate time signal, and a digital display driver 1214 linked with the CPU core 1211 for generating time or utility information display, such as weather forecast display, in a digital format.

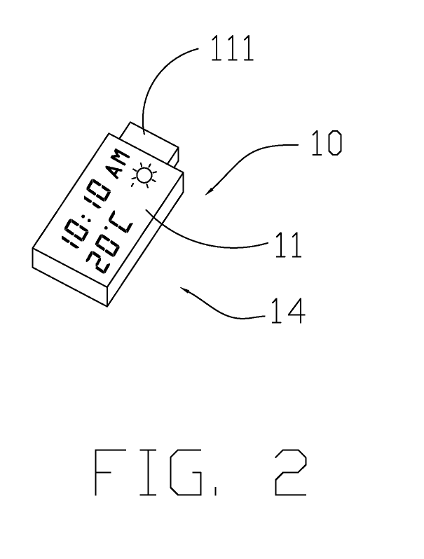

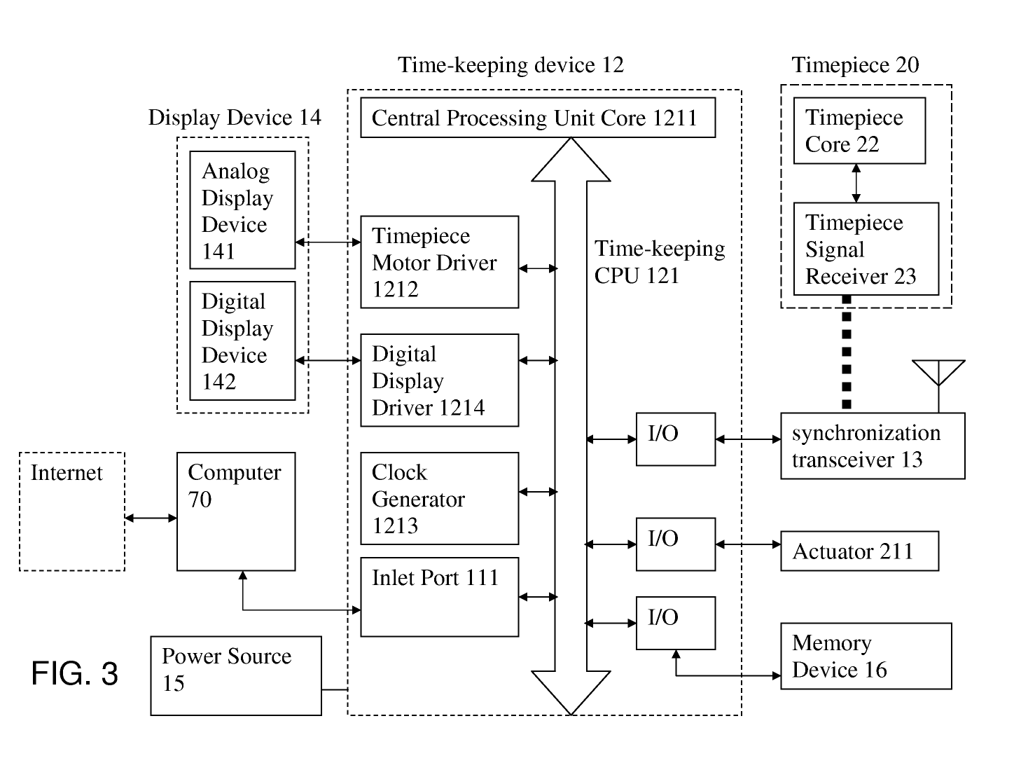

As shown in FIG. 2 to FIG. 3 of the drawings, the time-keeping synchronization hub 10 further comprises a display device 14 electrically communicated with the time-keeping CPU 121 for displaying time and utility information, such as the weather forecast information. The display device 14 comprises an analog time display 141 provided on the hub casing 11 and is connected with the timepiece motor driver 1212 of the time-piece CPU 121 for displaying time in analog manner. Moreover, the display device 14 further comprises a digital display 142 also provided on the hub casing 11 and is electrically communicated with the digital display driver 1214 and is arranged to display the utility information, such as the weather forecast information, in a digital format. It is worth mentioning that the analog time display 141 and the digital display 142 may be utilized in many ways according to marketing or manufacturing circumstances. For example, the time information may be displayed by the analog time display 141 or the digital display 142 (in such a case both the time information and the weather forecast information are displayed by the digital display 142). Alternatively, the time information is shown by the analog time display 141 and the weather forecast information is shown by the digital display 142. Accordingly, the time signal generated by the CPU core 1211 is for the digital display 142 or the analog time display 141 to display time information in analog or digital format. Moreover, the display device 14 may comprise only the digital display 142 wherein the time information and the utility information are all displayed by the digital display 142.

In other words, the time and utility information displayed by the time-keeping synchronization hub 10 can all be in a digital format so that the analog time display 141 may not be needed (as shown in FIG. 2). The exact format of time and utility information display by the time-keeping synchronization hub 10 depends on the circumstances in which the present invention is to be utilized or manufactured.

The time-keeping synchronization hub 10 further comprises a power source 15 (such as a battery) and a memory device 16 linked with the CPU core 1211 for storing data. The memory device 16 may comprise an internal memory or/and an external flash memory detachably connected with the time-keeping synchronization hub 10. It is important to mention that the time-keeping synchronization hub 10 of the present invention is battery powered so that even if the computer 70 is switched off, its timekeeping data can still be sent out to the timepiece for synchronization.

According to the preferred embodiment of the present invention, the CPU core 1211 is pre-programmed to periodically synchronize with the time information and utility information, such as the weather forecast information, acquired from the internet and control the timepiece motor driver 1212 and the digital display driver 1214 to adjust the displayed time and utility information accordingly. After the synchronization is completed, the time-keeping of the time-keeping synchronization 11 is arranged to run as though it is an independent timepiece, wherein the time and utility information such as the weather forecast information are shown by the display device 14. The period of synchronization can be adjusted by programming the CPU core 1211 to fit different circumstances of applications. As such, updated time and utility information, such as the weather forecast information, with minimal tolerance can be displayed by the display device 14.

The synchronization transceiver 13 is electrically connected with the time-keeping CPU 121 and is arranged to periodically transmit synchronized time information and utility information, such as the weather forecast information, in a wireless manner as time signal and utility information signal (such as weather forecast signal) respectively. The computer 70 is arranged to be programmed to acquire time and weather forecast information from an authoritative source, such as an official source of time delivering time information generated by atomic clock or an official observatory. Thus, the accuracy of the time and utility information acquired by the present invention can be ensured. Note that the synchronization transceiver 13 may utilize a wide range of wireless data transmission technology, such as RF transmission.

The timepiece signal transceiver 23 is internally provided in the timepiece 20, and is arranged to receive the time and utility information signal, such as the weather forecast signal, wirelessly transmitted from the synchronization transceiver 13. The timepiece can be a clock or a watch located within a predetermined maximum distance from the time-keeping synchronization hub 10 so as to receive the time and utility information. The timepiece signal receiver 23 is electrically connected with the timepiece core 22 in such a manner that the timepiece core 22 is arranged to synchronize with time and utility information, such as the weather forecast information, transmitted from the synchronization transceiver 13. The timepiece signal transceiver 23 is preferably embodied as a RF signal receiver for receiving the RF signal transmitted from the time-keeping synchronization hub 10.

The operation of the present invention is as follows: a user may purchase an entire system of the internet synchronization timepiece system and install a predetermined program to the computer 70. The program is capable of acquiring time and utility information such as the weather forecast information from a predetermined source through connecting to internet. After that the user may connect the time-keeping synchronization hub 10 to the USB port of the computer 70. The time-keeping device 12 is then arranged to periodically synchronize with the time and utility information acquired from internet. The time and utility information such as the weather forecast information are then displayed by the display device 14. Moreover, the synchronized time and weather forecast information are wirelessly transmitted by the synchronization transceiver 13 to the timepiece signal transceiver 23 of the timepiece 20. The timepiece signal transceiver 20 will then transmit the signal to the timepiece core 22 which is then arranged to synchronize with the time and utility information signal received by the timepiece signal transceiver 23. The time and the utility information such as the weather forecast information displayed by the timepiece core 22 will then accurately reflect the time and weather forecast information acquired from the internet. The utility information will be periodically updated through internet by the time-keeping synchronization hub 10.

It is important to mention that the time-keeping synchronization hub 10 is capable of simultaneously transmitting synchronized time and utility information to a plurality of timepieces 20 located in the vicinity of the time-keeping synchronization hub 10 so that all of the timepieces 20 can be synchronized to best follow the most up-to-date time and say, weather forecast information. Moreover, other sorts of information apart from time and weather forecast information may also be conveniently acquired. These include, but not limited to, relative humidity, outdoor temperature, wind direction etc. The exact information acquired and displayed by the time-keeping synchronization hub 10 can also be amended by programming the computer 70.

The present invention possesses several advantages over prior related products. First, take weather forecast information as the utility information as an example, the present invention allows timepieces 20 to acquire up-to-date time and weather forecast and/or other information even if the radio signal reception is not good (e.g. in indoor environment) because the time and weather forecast or other information are acquired through internet, and not from wireless radio frequency signal. Moreover, only a single time-keeping synchronization hub 10 is needed for synchronizing a number of timepieces 20. Third, each of the timepieces 20 has its own time-keeping function so that even when the computer 70 is not somehow connected to internet, the timepieces 20 can work as regular timepieces 20. Periodic synchronization suffices for keeping the time and weather forecast information the most accurate and up-to-date. The period between each two synchronizations and between each two components of the present invention can be freely programmed and adjusted in the computer 70 according to specific needs.

Moreover, in order to further enhance the application of the present invention, a time-keeping synchronization hub 10 may be made to be compatible with any timepiece having a timepiece signal transceiver 23 and the synchronization function. In other words, a manufacturer of the present invention may manufacture only the time-keeping synchronization hub 10 for use in conjunction with any timepiece 20 having an appropriate timepiece signal transceiver 23 and the required synchronization ability. The time-keeping synchronization hub 10 as a stand-alone invention is also covered by this patent application.

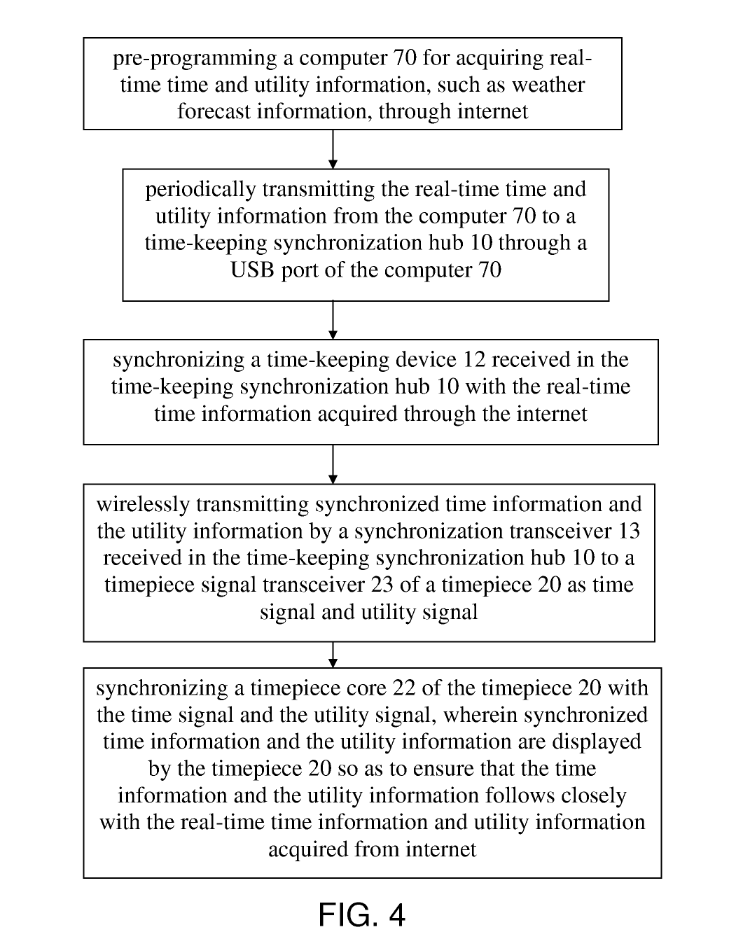

As shown in FIG. 4 of the drawings, the present invention also provides a method of displaying time and utility information, such as weather forecast information, comprising the steps of:

(a) pre-programming a computer 70 for acquiring real-time time and utility information, such as weather forecast information, through internet;

(b) periodically transmitting the real-time time and utility information from the computer 70 to a time-keeping synchronization hub 10 through a USB port of the computer 70;

(c) synchronizing a time-keeping device 12 received in the time-keeping synchronization hub 10 with the real-time time information acquired through the internet;

(d) wirelessly transmitting synchronized time information and the utility information, such as the weather forecast information, by a synchronization transceiver 13 received in the time-keeping synchronization hub 10 to a timepiece signal transceiver 23 of a timepiece 20 as time signal and utility signal; and

(e) synchronizing a timepiece core 22 of the timepiece 20 with the time signal and the utility signal, wherein synchronized time information and the utility information are displayed by the timepiece 20 so as to ensure that the time information and the utility information follows closely with the real-time time information and utility information acquired from internet.

Step (b) comprises a sub-step of periodically updating the utility information by the time-keeping synchronization hub 10 so that the displayed utility information by the time-keeping synchronization hub 10 can be kept up-to-date. Moreover, the method further comprises a step of displaying time and utility information by the time-keeping synchronization hub 10 which can also be embodied as a timepiece device.

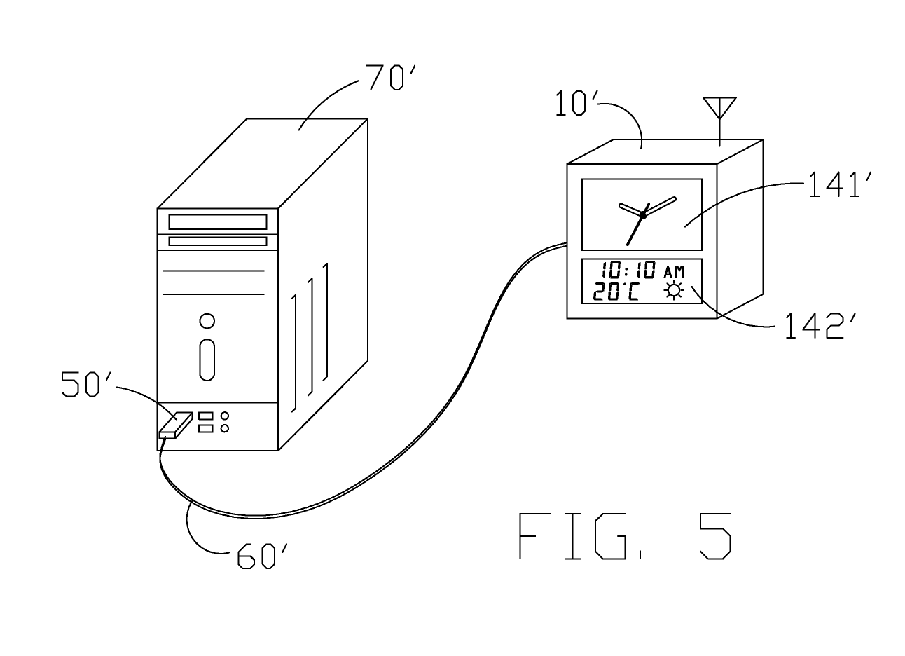

Referring to FIG. 5 of the drawings, an alternative mode of the present invention according to the preferred embodiment of the present invention is illustrated. The alternative mode is similar to the preferred embodiment, except that the internet synchronization timepiece system further comprises a connection device 50′ connecting to the USB port of the computer 70′, and a connection cable 60′ connecting the time-keeping synchronization hub 10′ and the connection device 50′, wherein the time-keeping synchronization hub 10′, having its analog time display 141′ and the digital display 142′, is itself embodied as a timepiece device for allowing a user to get time and weather forecast information directly from the time-keeping synchronization hub 10′. The time and utility information is obtained by the computer 70′ is transmitted to the time-keeping synchronization hub 10′ through the connection device 50′ and the connection cable 60′. In other words, the time-keeping synchronization hub 10′ of the present invention is provided with an additional feature as an addition timepiece device apart from the features disclosed in the preferred embodiment above.

One having ordinary skill in the art will appreciate that the embodiment of the present invention as shown in the drawings and described above is illustrative only and not intended to be limiting. All embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An internet synchronization timepiece system, comprising:
a time-keeping synchronization hub, which comprises:
a hub casing adapted for electrically connected with a computer which is pre-programmed to periodically send out real-time time and utility information acquired from internet to said inlet port;
a time-keeping device received in said hub casing and electrically connected with said inlet port of said hub casing for periodically receiving said real-time time and said utility information acquired through internet, wherein said time-keeping device is periodically synchronized with said real-time time information acquired through said internet; and
a synchronization transceiver received in said hub casing for transmitting synchronized time information and said utility information in a wireless manner as time signal and utility signal; and
a timepiece, which comprises:
a timepiece casing;
a timepiece core comprising a time displaying device received in said casing; and
a timepiece signal transceiver received in said timepiece casing and electrically connected with said timepiece core for wirelessly receiving said time signal and said utility signal in a periodic manner, wherein said timepiece core is arranged to synchronize with said time signal and interpret said utility signal to display said utility information and said time information transmitted from said time-keeping synchronization hub by said time displaying device.

2. The internet synchronization timepiece system, as recited in claim 1, wherein said time-keeping device comprises a time-keeping Central Processing Unit (CPU) electrically communicated with said synchronization transceiver, and comprises a CPU core, a timepiece motor driver linked with said CPU core, a clock generator linked with said CPU core and is arranged to generate time signal, and a digital display driver linked with said CPU core for generating said time information and said utility information display in a digital format.

3. The internet synchronization timepiece system, as recited in claim 2, wherein said time-keeping synchronization hub further comprises a display device electrically communicated with said time-keeping CPU, wherein said display device comprises a digital display provided on said hub casing and is connected with said digital display driver of said time-piece CPU for displaying at least one of said time information and said utility information in a digital format.

4. The internet synchronization timepiece system, as recited in claim 3, wherein said display device further comprises an analog time display provided on said hub casing and is electrically communicated with said timepiece motor driver and is arranged to display said time information in analog format.

5. The internet synchronization timepiece system, as recited in claim 2, wherein said time-keeping CPU is pre-programmed to periodically synchronize with said time information and utility information acquired from said internet and control said timepiece motor driver and said digital display driver to adjust said displayed time and utility information accordingly.

6. The internet synchronization timepiece system, as recited in claim 3, wherein said time-keeping CPU is pre-programmed to periodically synchronize with said time information and utility information acquired from said internet and control said timepiece motor driver and said digital display driver to adjust said displayed time and utility information accordingly.

7. The internet synchronization timepiece system, as recited in claim 4, wherein said time-keeping CPU is pre-programmed to periodically synchronize with said time information and utility information acquired from said internet and control said timepiece motor driver and said digital display driver to adjust said displayed time and utility information accordingly.

8. The internet synchronization timepiece system, as recited in claim 2, wherein said timepiece signal transceiver and said synchronization transceiver wirelessly and periodically communicate by radio frequency signal.

9. The internet synchronization timepiece system, as recited in claim 4, wherein said timepiece signal transceiver and said synchronization transceiver wirelessly and periodically communicate by radio frequency signal.

10. The internet synchronization timepiece system, as recited in claim 7, wherein said timepiece signal transceiver and said synchronization transceiver wirelessly and periodically communicate by radio frequency signal.

11. The internet synchronization timepiece system, as recited in claim 1, wherein said utility information is weather forecast information.

12. The internet synchronization timepiece system, as recited in claim 4, wherein said utility information is weather forecast information.

13. The internet synchronization timepiece system, as recited in claim 7, wherein said utility information is weather forecast information.

14. The internet synchronization timepiece system, as recited in claim 10, wherein said utility information is weather forecast information.

15. The internet synchronization timepiece system, as recited in claim 7, wherein said time-keeping synchronization hub further comprises a power source and a memory device linked with the time-keeping CPU for storing data.

16. The internet synchronization timepiece system, as recited in claim 10, wherein said time-keeping synchronization hub further comprises a power source and a memory device linked with the time-keeping CPU for storing data.

17. The internet synchronization timepiece system, as recited in claim 14, wherein said time-keeping synchronization hub further comprises a power source and a memory device linked with the time-keeping CPU for storing data.

18. The internet synchronization system, as recited in claim 10, further comprising a connection device connecting to said USB port of said computer, and a connection cable connecting said time-keeping synchronization hub and said connection device, wherein said time-keeping synchronization hub is embodied as a timepiece device for allowing a user to get said time and said utility information directly from said time-keeping synchronization hub.

19. The internet synchronization system, as recited in claim 14, further comprising a connection device connecting to said USB port of said computer, and a connection cable connecting said time-keeping synchronization hub and said connection device, wherein said time-keeping synchronization hub is embodied as a timepiece device for allowing a user to get said time and said utility information directly from said time-keeping synchronization hub.

20. A method of displaying time and utility information, comprising the steps of:
(a) pre-programming a computer for acquiring real-time time and utility information through internet;
(b) periodically transmitting said real-time time and said utility information from said computer to a time-keeping synchronization hub through a USB port of said computer:
(c) synchronizing a time-keeping device received in said time-keeping synchronization hub with said real-time time information acquired through said internet;
(d) wirelessly transmitting synchronized time information and said utility information by a synchronization transceiver received in said time-keeping synchronization hub to a timepiece signal transceiver of a timepiece as time signal and utility signal; and
(e) synchronizing a timepiece core of said timepiece with said time signal and said utility signal, wherein synchronized time information and said utility information are displayed by said timepiece so as to ensure that said time information and said utility information follows closely with said real-time time information and utility information acquired from internet.

21. The method, as recited in claim 20, wherein said timepiece signal transceiver and said synchronization transceiver wirelessly and periodically communicate by radio frequency signal.

22. The method, as recited in claim 21, wherein said utility information is weather forecast information.

23. A time-keeping synchronization hub for connecting between a computer and a timepiece having a timepiece core and a timepiece signal transceiver, wherein said time-keeping synchronization hub comprises:
a hub casing adapted for electrically connected with a computer which is pre-programmed to periodically send out real-time time and utility information acquired from internet to said inlet port;
a time-keeping device received in said hub casing and electrically connected with said inlet port of said hub casing for periodically receiving said real-time time and said utility information acquired through internet, wherein said time-keeping device is periodically synchronized with said real-time time information acquired through said internet; and
a synchronization transceiver received in said hub casing for wirelessly transmitting synchronized time information and said utility information as time signal and utility signal to said timepiece signal transceiver in such a manner that when said timepiece signal transceiver is adapted to receive said time signal and said utility signal in a periodic manner, so that said timepiece core is to be synchronized with said time signal and interpret said utility signal to display said utility information and said time information transmitted from said time-keeping synchronization hub by timepiece.

24. The internet synchronization timepiece system, as recited in claim 23, wherein said time-keeping device comprises a time-keeping Central Processing Unit (CPU) electrically communicated with said synchronization transceiver, and comprises a CPU core, a timepiece motor driver linked with said CPU core, a clock generator linked with said CPU core and is arranged to generate time signal, and a digital display driver linked with said CPU core for generating said time information and said utility information display in a digital format.

25. The internet synchronization timepiece system, as recited in claim 24, wherein said time-keeping synchronization hub further comprises a display device electrically communicated with said time-keeping CPU, wherein said display device comprises a digital display provided on said hub casing and is connected with said digital display driver of said time-piece CPU for displaying at least one of said time information and said utility information in a digital format.

26. The internet synchronization timepiece system, as recited in claim 25, wherein said display device further comprises an analog time display provided on said hub casing and is electrically communicated with said timepiece motor driver and is arranged to display said time information in analog format.

27. The internet synchronization timepiece system, as recited in claim 25, wherein said time-keeping CPU is pre-programmed to periodically synchronize with said time information and utility information acquired from said internet and control said timepiece motor driver and said digital display driver to adjust said displayed time and utility information accordingly.

28. The internet synchronization timepiece system, as recited in claim 27, wherein said timepiece signal transceiver and said synchronization transceiver wirelessly and periodically communicate by radio frequency signal.

29. The internet synchronization timepiece system, as recited in claim 28, wherein said utility information is weather forecast information.

30. The internet synchronization timepiece system, as recited in claim 29, wherein said time-keeping synchronization hub further comprises a power source and a memory device linked with the time-keeping CPU for storing data.
